(19) United States
(12) Patent Application Publication
(10) Pub. No.: US 2006/0043008 A1
(43) Pub. Date: Mar. 2, 2006

(54) Reverse osmosis water purification system

(76) Inventor: Mike Joulakian, Glendale, CA (US)

Correspondence Address: DON B. FINKELSTEIN, ESQ.;LAW OFFICES OF DON FINKELSTEIN, SUITE 216, 3858 CARSON STREET, TORRANCE, CA, 90503, US

(21) Appl. No.: 10/924,401

(22) Filed: Aug. 24, 2004

(51) Int. Cl. B01D 61/12

(52) U.S. Cl. 210/110; 210/321.65; 210/449; 210/418; 210/321.69

(57) ABSTRACT

A tankless, pumpless on demand reverse osmosis water purification system with provisions for flushing water from the product water tube and water supply line to the faucet which water is not the fully purified water provided by the reverse osmosis action before allowing the dispensing of the reverse osmosis purified water.

### BACKGROUND OF THE INVENTION

1. Field of the Invention

This invention relates to the water purification art and more particularly to a tankless, pumpless on-demand reverse osmosis water purification system

2. Description of the Prior Art

Over the years there has been an increasing pollution of the water supplies utilized for human consumption, and as populations increase worldwide there is expected to be an accompanying greater amount of pollutants produced which find their way into the water supply. Many of the pollutants are the result of the societal technological advancements and industrial activities which produce more products for human use but also produce more waste products. These waste products may include many toxic contaminants as well as unpleasant or undesired particulate materials which contaminate the aquifers and the water supplies. Such pollution of the water supply has caused many people to install water purification systems in their residences to purify further the tap water supplied by a local municipality. That is, while the municipalities in the industrial nations often add chemicals such as chlorine to the water supply, the resultant water is often not of a quality that many persons find acceptable for use.

One of the primary types of home water purification systems is the reverse osmosis systems. Such reverse osmosis systems come in many varieties and configurations. These prior art reverse osmosis units can be broadly classified into the under the counter units or over the counter units.

In general the under the counter prior art reverse osmosis units have all of the filtration components secured under the counter which has the sink containing the water input from the municipality from which the input water to the reverse osmosis system is obtained and the faucet from which the purified water is dispensed. These prior art under the counter units have incorporated a semi-permeable filter membrane in a tubular type of pressure vessel. The semi-permeable filter membrane permits water molecules to pass therethrough in a particular direction but is impermeable to certain impurities in the water such as nitrates, heavy metals and salts, chemical fertilizers and many viruses and bacteria. A product water tube is provided in the center of the pressure vessel and is perforated to allow water to flow to the interior of the product water tube from the semi-permeable membrane. The product water tube is surrounded by the semi-permeable membrane. The inlet water from the municipality is introduced into the semipermeable membrane at the household water pressure which may be on the order of 40 to 80 pounds per square inch, though some localities may have higher or lower pressures as the household water pressure. However, where the inlet water pressure is too low to provide a proper reverse osmosis operation, it may be necessary to include a pump at the inlet water line to bring the pressure up to a value that is sufficient for proper reverse osmosis operation. By reverse osmosis, a fixed amount of the water supplied to the semi-permeable membrane is forced into the outlet tube. Particulate matter in the municipality supplied water delivered to the membrane is removed from the portion of the water forced into the product water tube. The water from the product water tube is the purified water or product water that is utilized. The product water tube often is connected to a tank which holds a supply of the product water from the product water tube and often a pump is utilized to pump the product water from the storage tank to the apparatus such as a faucet from which the water is dispensed. In many under the counter reverse osmosis units there has also been provided an activated charcoal or carbon filter stage to remove taste-causing impurities such as chlorine and the like from the product water. Under the counter units are usually professionally installed but, nevertheless, are unobtrusive do the hidden location in the cabinet under the counter. However, the prior art under the counter reverse osmosis systems do take up considerable space in the counter under the sink. Since this under the counter space is often crowded with the pipes and other connectors for the water supply, a garbage disposal unit, a hot water dispenser, as well as numerous boxes of supplies for use at the sink. Thus, space under the counter for all these items has become limited and a reduction in size of the under the counter reverse osmosis system is often desired.

Over the counter reverse osmosis units are generally much smaller than the under the counter reverse osmosis units so as not to take up counter space in the area near the faucet. As such, the over the counter units do not incorporate a tank to store water but often have limited carbon filtration capabilities as well as smaller semipermeable membranes. The small size tends to limit the filtration flow rate as well as requiring more frequent replacement of the semipermeable membrane filter element and/or the charcoal or carbon filter. Many of the prior art reverse osmosis over the counter systems may be considered “on demand” systems since the water to be used by the consumer flows directly to the faucet from the product water tube of the reverse osmosis unit as there is no storage tank.

When the reverse osmosis unit is not in use in that there is not any water flowing through the semipermeable membrane, the reverse osmosis action ceases as there is no osmotic supply pressure in a flowing stream of water forcing the water through the semipermeable membrane. As such, some water migrates through the static water in the semipermeable membrane and into the product water tube. Such migrating water is not as filtered as the water provided by the reverse osmosis operation. When the faucet is then turned on, the first water out of the product water tube is not the fully filtered reverse osmosis water. This is undesirable to the consumer and has limited the acceptability of the prior art “on demand” reverse osmosis units. In the reverse osmosis units in which a storage tank is utilized to store a predetermined amount of purified water, the effect of the migrating water during the time there is no water flowing from the inlet through the membrane, water in the product water tube of the reverse osmosis unit is highly diluted. The storage tank, though, takes up valuable under the counter space.

In reverse osmosis filtration systems, the municipality supplied household water pressure is typically on the order of 40 pounds per square inch to 80 pounds per square inch. With such osmotic pressure, there is provided about one gallon of purified water into the product water tube to be used by the consumer and about three gallons of waste water, often called brine, according to the operation of the present invention, that is discarded into the drain. Since impurities have been filtered out by the reverse osmosis action, the remaining brine has a higher concentration of impurities than the inlet supply water and thus is not considered to be usable by the consumer and is, therefore, discarded. Consequently, there is often provided a connection from the reverse osmosis unit for directing the brine to the waste water drain.

Thus, there has long been a need for an under the counter reverse osmosis unit that is compact in size and volume and still provides an acceptable flow rate of purified water without the introduction of unpurified water to the consumer.

Accordingly, it is an object of the present invention to provide an improved under the counter reverse osmosis unit that is compact in size.

It is another object of the present invention to provide an under the counter reverse osmosis unit that is free of a storage tank and free of a pump.

It is another object of the present invention to provide an under th counter reverse osmosis unit that provides the purified water on demand without using a storage tank for holding a supply of purified water.

It another object of the present invention to provide an under the counter reverse osmosis unit that allows on demand provision of purified water but does not allow water to be used by the consumer which is not subjected to the purification provided by reverse osmosis to be dispensed to the user.

It is yet another object of the present invention to provide a more efficient reverse osmosis water purification system that minimizes the amount of waste water of brine.

It is yet another object of the present invention to provide a reverse osmosis water purification system in which both a pre-filter stage or post filter stage such as provided by a charcoal filter is encased in the same pressure vessel as the reverse osmosis water purification components.

### SUMMARY OF THE INVENTION

The above and other objects of the present invention are achieved, in a preferred embodiment thereof, by providing a pressure vessel in which there is a semipermeable membrane having a central cavity. A perforated product water tube is provided in the central cavity of the semipermeable membrane. A carbon filter stage in the form of an activated carbon cake is provided to treat the water. Depending upon the location of the carbon cake, it can be utilized to treat all the water introduced into the semipermeable membrane or to treat the purified water coming out of the outlet tube.

Depending upon the placement of the activated charcoal, water from the municipality is fed into the reverse osmosis unit. As noted above, in one embodiment of the present invention, all of the water passes through the carbon cake and then into the semipermeable membrane in which embodiment all of the inlet water is treated by the charcoal. In another embodiment of the present invention the charcoal filter is placed at the product water tube so that only the water flowing from the product water tube is filtered by the charcoal filter. The municipal water supply is at a pressure, for example in the range of 40 to 80 pounds per square inch to provide the osmotic pressure to the reverse osmosis unit. As noted above, if the inlet water pressure is too low, a pump may be utilized to boost the inlet water pressure to a value sufficient for proper reverse osmosis operation. The flowing water through the membrane forces a portion thereof through the membrane and into the product water tube. The product water tube is connected directly to the faucet. As noted above, when the faucet is first turned on after a period of non use, the first water which would flow the faucet may not be as fully filtered because of migration of the waster through the membrane during the periods of non use. In preferred embodiments of the present invention, a flow control system is provided and includes a solenoid operated diverter valve arrangement to prevent the first flow of water from the product water tube entering the faucet and diverts the first flow of water into the water drain. After a very brief time interval, the diverter valve arrangement directs the water from the product water tube into the faucet for consumption. The unique flow control system of the present invention provides the increased efficiency to minimize the waste water.

The activated carbon stage of filtration may, if desired, be placed downstream of the product water tube so that only the water flowing from the product water tube is treated by the activated charcoal.

### BRIEF DESCRIPTION OF THE DRAWING

The above and other embodiments of the present invention my be more fully understood from the following detailed description taken together with the accompanying drawing wherein similar reference characters refer to similar elements throughout and in which:

FIG. 1 illustrates a preferred embodiment of the present invention;

FIG. 2 illustrates an alternate faucet embodiment useful in the practice of the present invention;

FIG. 3 illustrates an product water tube useful in the practice of the present invention;

FIG. 4 is a schematic diagram of the flow control system useful in the practice of the present invention; and,

FIG. 5 illustrates another embodiment of the present invention.

### DESCRIPTION OF THE PREFERRED EMBODIMENTS

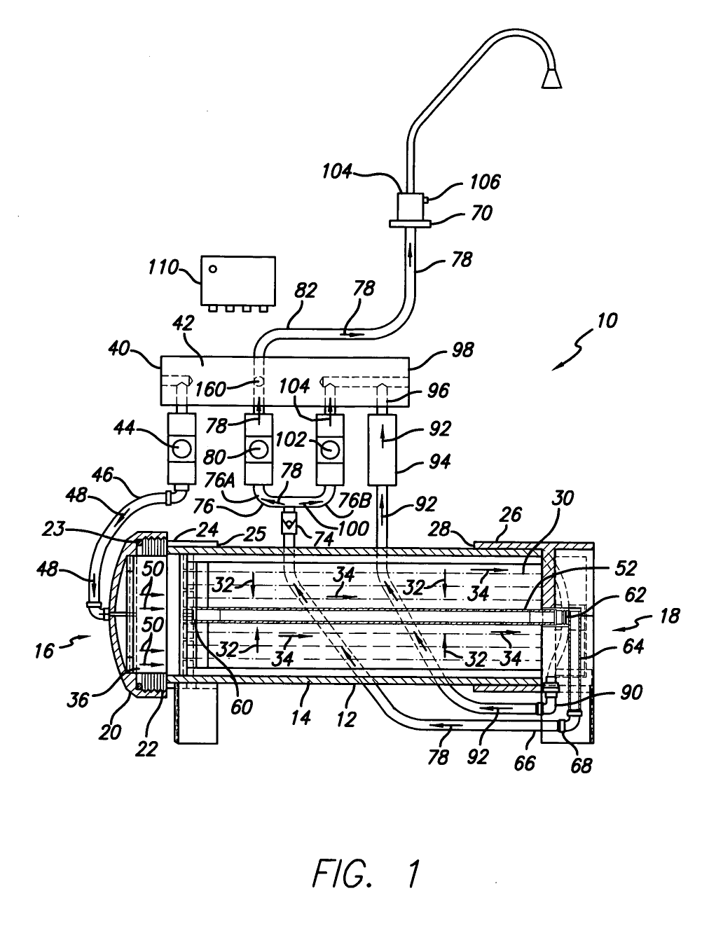

Referring now to the drawing there is illustrated on FIG. 1 a preferred embodiment of the present invention of a tankless, pumpless on demand reverse osmosis water purification system generally designated 10. The embodiment 10 has a pressure vessel 12 comprised of a generally tubular body member 14, an inlet end 16 and a discharge end 18. The inlet end 16 has an inlet end cap 20 that is threadingly coupled to the body member 14 as indicated at 22 through an adapter 24 that is fixedly coupled to the body member 14 as indicated at 25. An “O” ring 23 may be provided between the adapter 24 and the inlet end cap 20 to provide a sealing engagement therebetween.

The discharge end 18 has a discharge end cap 26 that is fixedly coupled to the body member 14 as indicated at 28. As assembled as shown on FIG. 1, the pressure vessel 12 is designed to withstand for continuous operation the operating pressure of the water supplied thereto which, for example, may be on the order of 40 to 80 pounds per square inch. The pressure vessel 12 contains a filter membrane 30 that may be, for example, spiral wound. The filter membrane 30 is a reverse osmosis membrane comprised of a suitable semi-permeable material, such as cellulose triacetate, polyamide or other suitable materials that slowly allows water molecules to pass therethrough in a radial direction as indicated by the arrows 32 while rejecting the passage of dissolved salts, minerals and suspended particles. A filter membrane 30 of cellulose triacetate is capable of removing from the water flow indicated by the arrows 32 such dissolved salts and minerals as lead, fluorides, cadmium, aluminum, sodium, arsenic, and nitrates. Such a filter membrane is also capable of preventing the passage of the water in the direction indicated by the arrows 32 smaller size particulate such as sand and clay. As is known in the prior art, the amount of water flowing in the radial direction indicted by the arrows 32 is less than the amount of water flowing axially in the direction of the arrows 34.

The pressure vessel 12 also is provided with a pre filter 36 such as a cake of activated carbon or the like which is utilized to remove, inter alia, the larger particulate mater in the water.

Water from the supplier of the water such as a municipality or the like provides the water at an inlet port 40 in a water manifold 42 at a predetermined pressure. Such pressure may be, for example, on the order of 40 pounds per square inch to 80 pounds per square inch though some localities may have a higher or lower inlet water pressure, pressure. The inlet water flows through an inlet solenoid valve 44 and into an inlet tube 46 flowing in the direction of the arrows 48 to the pressure vessel 12. All of the water from the inlet tube flows through the pre-0filter 36 in the direction of the arrows 50. After passing through the pre-filter 36 the water flows through the membrane 30 in the directions of the arrows 34 in axial direction and the arrows 32 in the radial direction.

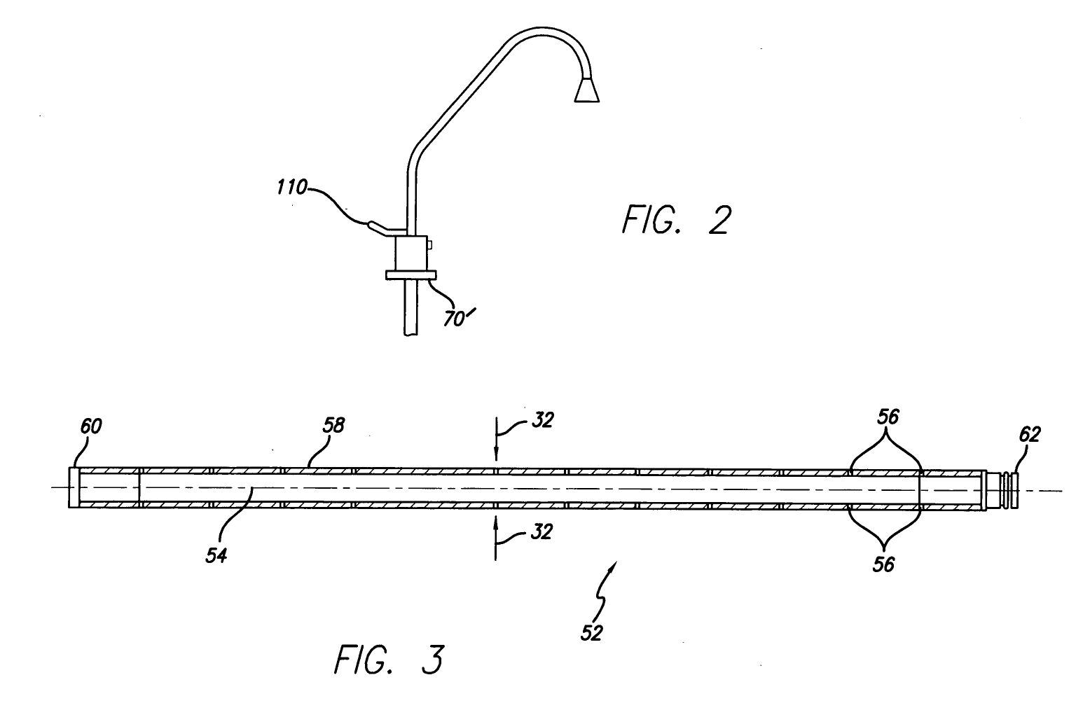

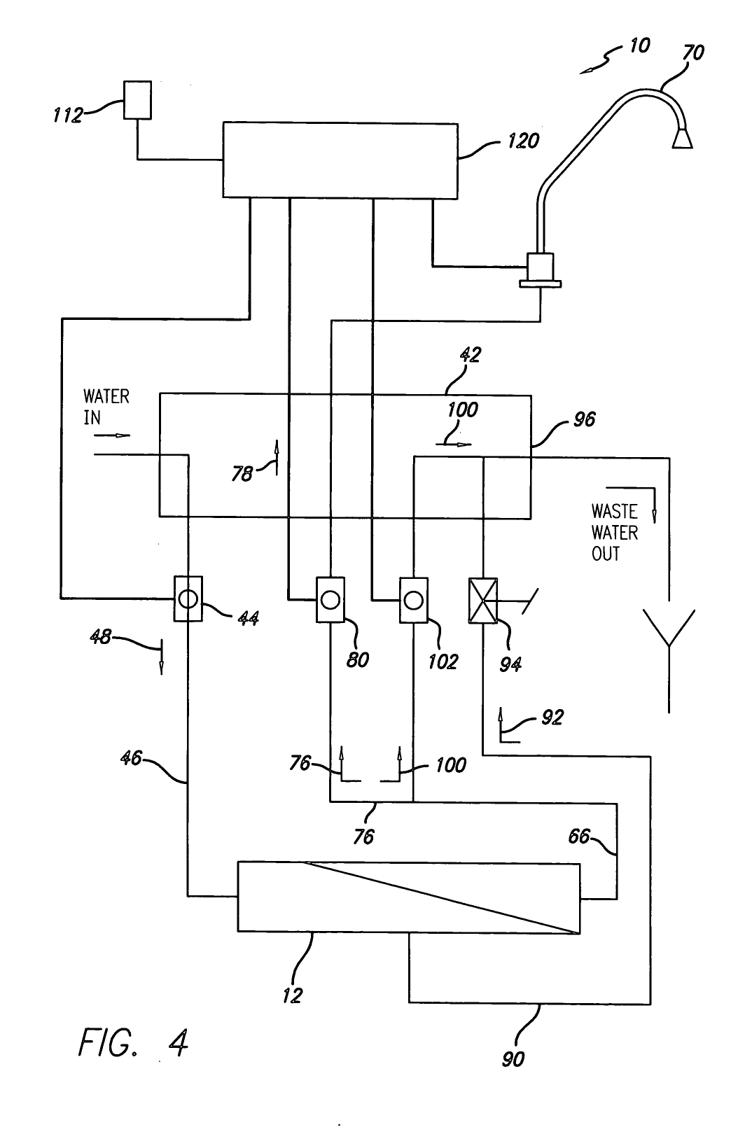

A product tube 52, which is illustrated in greater detail on FIG. 3 is in the center of the pressure vessel 14 and the membrane 30 is wrapped therearound. The product tube 52 as shown on FIG. 3 is tubular about a centerline 54 and is provided with a plurality of apertures 56 through the wall 58 thereof to allow the water flowing in the direction of the arrows 32 to enter the interior 60 of the product tube 52. Water flows in the product tube 52 from a first end 60 to a second end 62 thereof. The first end 60 is sealed closed to prevent the water flowing from the carbon cake pre-filter 36 from entering the first end 60 of the product tube 52. The second end 62 of the product tube 52 is connected to a transfer tube 64 which is connected to a product tube 66 as indicated at 68. For the condition of water flowing through the semi-permeable membrane 30 at the osmotic pressure provided by the inlet water pressure, the water flowing in the direction of the arrows 32 in the semi-permeable membrane 30 is the water purified by reverse osmosis that is directed to a faucet 70. The water flowing in the product tube 66 as indicated by the arrows 72 passes through a check valve 74 and into a branched tube 76. Water flowing into the branched tube 76 in the direction of the arrow 78 is directed to flow through a faucet solenoid valve 80 and into a faucet supply tube 82 and then is directed to the faucet 70.

As shown on FIG. 1, the water flowing through the semi-permeable membrane 30 in the direction of the arrows 34 is the waste water or brine. The waste water is directed into a discharge tube 90 as indicted by the arrows 92 and, in a preferred embodiment of the present invention, through a valve 94 and into a discharge port 96 in the manifold 42 and to the drain port 98 in the manifold 42 for draining to the household waste water connection.

The valve 94 is a flow control valve that is preset upon installation to control the amount of water flow rate through the embodiment 10. Since the amount of water that is purified by the reverse osmosis action as indicted by the arrows 78 as flowing to the faucet 70 is on the order of, for example, 18 to 25 per cent of the total water flowing into the embodiment 10 as indicated by the arrow 48, the valve 94 is adjusted to provide a sufficient pressure drop there across so that this desired purified water flow rate is maintained for the inlet water pressure at the place of installation. The valve 94 could, if desired, be replaced by a given length of small diameter tubing that provides the pressure r drop required to achieve the specified purified water flow rate. The setting of the valve 94 or the length of tubing utilized to provide the pressure drop is a one time setting since the inlet water pressure, at the point of installation in general does not vary with time in a significant amount to require a different setting.

It has been found that for the condition of water not flowing through the semi-permeable membrane 30, that is, for example, when the inlet solenoid valve 44 is closed, the water in the semi-permeable membrane is static. In such a condition, it has been found that the water flowing in the direction of the arrows 32 into the product tube 52 does not undergo the reverse osmosis purification and there is a creep of the unpurified water from the semi-permeable membrane 30 into the product tube 52. According to the principles of the present invention, the water in the product tube 52 for the condition of the faucet being opened to initiate the flow of water through the semi-permeable membrane 30 is first directed to the branch 76B of the diverter tube 76 by maintaining the solenoid 80 closed and into a flush solenoid 102. Such water flows into the flush port 104 of the manifold 42 and then to the discharge port 98. After a predetermined time period calculated by the time necessary to purge the water from the product tube and allow the purified water from the reverse osmosis action to fill the product tube, the flush solenoid valve 102 is closed and the faucet solenoid valve 80 is open allowing water to flow to the faucet 70 As shown on FIG. 1, the facet 70 is provided with a button 104 that is depressed to initiate the flow of water. Indicator lights may also be provided on the faucet 70 as described below in greater detail.

As shown on FIG. 2, there is depicted an alternate form of a faucet 70′ useful in the practice of the present invention. The faucet 70′ is similar to the faucet 70 except that a lever 110 is provided to open the faucet instead of the button 104.

Referring now to FIG. 4 there is shown a schematic diagram of the embodiment 10. As shown on FIG. 4, there is provided a control box 120 powered by the electrical input from the transformer 112 which is supplied with, for example 110 to 220 volt, 50 to 60 cycle AC power and delivers 12 volts DC to the control box 120. The inlet solenoid 44, the faucet solenoid 80 and the flush solenoid 102 are normally closed solenoids. When actuated, they open to allow the flow of water therethrough. When they are closed, no water is permitted to flow therethrough. When it is desired to obtain water from the faucet 70, the faucet 70 is actuated by pressing the button 104 or the lever 110 (FIG. 2) or any other structure utilized to open the faucet. Upon actuation, an actuation signal is sent from the faucet to the control box 120. The control box 120 has a micro processor therein which is provided with a plurality of adjustable switches. Upon receiving the actuation signal from the faucet 70, the micro processor in the control box 120 sends a first control signal to open the inlet solenoid 44 and a second control signal to the flush solenoid 102. After a predetermined time interval which may be set by the switches in the micro processor, a the second control signal to the flush solenoid 102 is terminated and the flush solenoid is closed. Upon closure of the flush solenoid 102 a third control signal is sent from the control box 110 to the faucet solenoid 80 and the faucet solenoid 80 is opened, thereby allowing water to flow from the faucet 70 (or 70′). Since under this condition water is flowing through the semi-permeable membrane 30, water purified by the reverse osmosis action flows into the product tube 52 and then to the faucet 70. The time interval that the flush solenoid 102 is open is determined by the size of the product tube, that is, how much water it contains and by the water pressure.

When the button 104 or the handle 110 is released, the actuation signal from the faucet 70 is terminated and the micro processor terminates the first control signal thereby closing the inlet solenoid 44 and terminates the third control signal thereby closing the faucet solenoid 80.

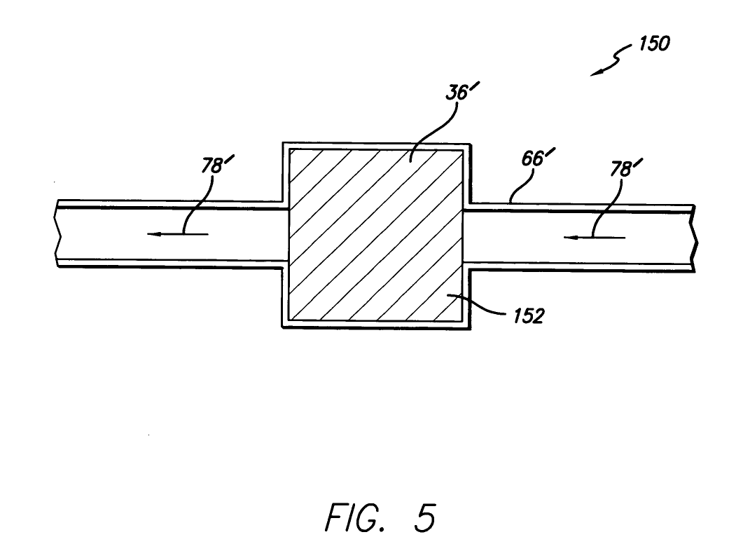

In the embodiment 10 as shown on FIG. 1, the carbon cake 10 provides the pre filtering action to all of the inlet water as indicated by the arrow 48. However, in some applications it has been found to be desirable to provide the pre-filter action of the carbon cake 36 only to the water flowing to the faucet 70. Such an arrangement allows the utilization of a smaller carbon cake and/or less frequent replacement thereof. FIG. 5 illustrates an embodiment 150 showing the purified water outlet line 66′; that is provided with a chamber 152 in which a carbon cake 36′ is placed. In the embodiment 150, only the water flowing to the faucet is passed through the carbon cake 36′.

In other applications it has been found desirable to provide the pre filtering action of the carbon by providing a carbon tube in the pressure vessel 14 and surrounding the semi-permeable membrane. In such an embodiment, the end of the semi-permeable membrane is sealed from the inlet water 48 so that all the inlet water is directed through the carbon tube. The opposite end of the semi-permeable membrane is open to the water after it has passed through the carbon tube and lows through the semi-permeable membrane to allow the reverse osmosis action to take place.

In some applications it may be desired to provide a an actuation signal from a source other than the faucet. In such an embodiment, a probe port 160 (FIG. 1) may be provided and a probe (not shown) inserted therein to detect the TDS in the water and generate an actuation signal in response to the detected TDS and send the actuation signal to the control box 110 for causing the generation of the various control signals to the solenoid valves 44, 80 and 102 as described above.

This concludes the description of the preferred embodiments of the present invention. As has been described above, the embodiments of the present invention provide a tankless, pumpless on demand reverse osmosis water purification system which is primarily designed for under the sink installation, though other locations for the installation may be utilized for particular applications. Although specific embodiments of the present invention have been described above with reference to the various Figures of the drawing, it should be understood that such embodiments are by way of example only and merely illustrative of but a small number of the many possible specific embodiments which can represent applications of the principles of the present invention. Various changes and modifications obvious to one skilled in the art to which the present invention pertains are deemed to be within the spirit, scope and contemplation of the present invention as further defined in the appended claims.

What is claimed is:

1. A reverse osmosis water purification system for receiving a tap water supply and for producing therefrom a relatively purified water supply, comprising, in combination:
a pressure vessel having a water inlet end and a waster discharge end;
a normally closed water inlet solenoid valve for receiving the tap water;
a reverse osmosis semi-permeable membrane in said pressure vessel;
a water inlet at said water inlet end of said pressure vessel for receiving the tap water from normally closed water inlet solenoid valve for the condition of said normally closed water inlet valve in the open position thereof and directing said tap water into said pressure vessel and through said semi-permeable membrane;
a product tube in said semi-permeable membrane for receiving reverse osmosis purified water from said semi-permeable membrane;
a faucet water conduit connected to said product tube for receiving said water from said product tube;
a branched diverter tube connected to said faucet water conduit for receiving the water from said faucet water conduit and having a faucet water branch and a flush water branch;
a normally closed faucet water solenoid valve in said faucet water branch;
a normally closed flush water solenoid valve in said flush water branch;
a faucet connected to said faucet water branch of said diverter tube downstream from said faucet water solenoid, said faucet having an open condition for allowing water to flow therethrough and a closed position for preventing water from flowing therethrough, and means for switching said faucet between said open condition and said closed condition;
control box means for selectively transmitting a first control signal to said water inlet solenoid valve, a second control signal to said faucet solenoid valve and a third control signal to said flush solenoid valve in response to receipt of an actuation signal; and,
means for generating said actuating signal.

2. The arrangement defined in claim 1 and further comprising:
a waste water conduit for receiving waste water from said semi-permeable membrane.

3. The arrangement defined in claim 2 and further comprising:
water flow control in said waste water conduit for controlling the flow rate of the water into said pressure vessel.

4. The arrangement defined in claim 1 and further comprising:
a carbon cake in said pressure vessel intermediate said water inlet and said semi-permeable membrane.

5. The arrangement defined in claim 1 and further comprising:
a carbon tube in said pressure vessel surrounding said semi-permeable membrane;
means for directing said inlet water through said carbon tube prior to said water entering said semi-permeable membrane.

6. The arrangement defined in claim 1 and further comprising:
a carbon cake in said faucet conduit intermediate said product tube and said faucet.

7. The arrangement defined in claim wherein:
moving said faucet to said open position thereof generates said actuation signal and moving said faucet to said closed position thereof terminates said actuation signal.

8. The arrangement defined in claim 7 wherein:
receipt of said actuation signal by said control box causes the generation of said first control signal, said second control signal and said third control signal.

9. The arrangement defined in claim 8 and further comprising:
a carbon tube in said pressure vessel surrounding said semi-permeable membrane; and,
means for directing said inlet water through said carbon tube prior to said water entering said semi-permeable membrane.

10. The arrangement defined in claim 8 and further comprising:
a carbon cake in said pressure vessel intermediate said water inlet and said semi-permeable membrane.

11. The arrangement defined in claim 8 and further comprising:
a carbon cake in said faucet conduit intermediate said product tube and said faucet.

12. The arrangement defined in claim 8 and further comprising:
a waste water conduit for receiving waste water from said semi-permeable membrane.

13. The arrangement defined in claim 12 and further comprising:
water flow control in said waste water conduit for controlling the flow rate of the water into said pressure vessel.

14. The arrangement defined in claim 9 and further comprising:
a waste water conduit for receiving waste water from said semi-permeable membrane.

15. The arrangement defined in claim 14 and further comprising:
water flow control in said waste water conduit for controlling the flow rate of the water into said pressure vessel.

16. The arrangement defined in claim 10 and further comprising:
a waste water conduit for receiving waste water from said semi-permeable membrane.

17. The arrangement defined in claim 16 and further comprising:
water flow control in said waste water conduit for controlling the flow rate of the water into said pressure vessel.

18. The arrangement defined in claim 11 and further comprising:
a waste water conduit for receiving waste water from said semi-permeable membrane.

19. The arrangement defined in claim 18 and further comprising:
water flow control in said waste water conduit for controlling the flow rate of the water into said pressure vessel.
